(19) United States
(12) Patent Application Publication
(10) Pub. No.: US 2023/0146876 A1
(43) Pub. Date: May 11, 2023

(54) Sensor Module for Being Attached to a Panel Component of a Motor Vehicle and Panel Component Comprising Such a Sensor Module

(71) Applicant: Webasto SE, Stockdorf (DE)

(72) Inventor: Magnus SVIBERG, Stockdorf (DE)

(21) Appl. No.: 17/946,815

(22) Filed: Sep. 16, 2022

(30) Foreign Application Priority Data
Nov. 11, 2021 (DE) 10 2021 129 392.8

(51) Int. Cl. B60R 11/04

(52) U.S. Cl. CPC B60R 11/04; B60R 2011/004

(57) ABSTRACT

A sensor module for being attached to a panel component of a motor vehicle, the sensor module may have a sensor housing, at least one environment sensor disposed at least partially in the sensor housing and configured to send and/or receive electromagnetic signals to thus detect a vehicle environment, and an adjustment kinematics system having a drive configured to move the environment sensor from a retracted position into at least one deployed position. A cover is disposed on the sensor housing in an adjustable manner, and the drive is configured to move the cover from a covering position into at least one open position.

### CROSS-REFERENCE TO RELATED APPLICATION

This application claims priority from German patent application no. 10 2021 129 392.8 filed on Nov. 11, 2021, which is hereby incorporated herein by reference in its entirety for all purposes.

### FIELD

The invention relates to a sensor module for being attached to a panel component of a motor vehicle according to the preamble of claim 1.

### BACKGROUND

Generic sensor modules are known from the state of the art and have been in use in vehicle manufacturing. For instance, sensor modules of this kind are used to monitor a parking process, ultrasound sensors being normally used as environment sensors.

Sensor modules of this kind often comprise a sensor housing and an environment sensor which is at least partially disposed in the sensor housing and which is configured to send and/or receive electromagnetic signals to thus detect a vehicle environment during a parking process, for example. The known sensor modules can be rigidly disposed on top of a panel component (a body part of the motor vehicle). However, such a disposition can be disadvantageous for an optical appearance of the motor vehicle since the prominence caused on the outer surface by the sensor module disturbs a visual contour of the body, which customers often perceive as negative. Moreover, a fixed disposition of a sensor module negatively affects the aerodynamics of the motor vehicle since undesired air turbulence can occur at said prominence during travel with the motor vehicle. This turbulence can lead to disturbing acoustic noise, which a vehicle passenger generally perceives as negative. Also, the aerodynamically disturbing contours can cause the fuel con-sumption of the motor vehicle to rise. Moreover, there is the risk that a see-through area through which the environment sensor detects the vehicle environment accumulates dirt because of permanent environmental and weather conditions and becomes opaque to the environment sensor or even damaged (e.g., by hail).

To partially solve these issues, it is known for a sensor module to be equipped with an adjustment kinematics system having a drive configured to move the environment sensor from a retracted position into a deployed position. Thus, the environment sensor can be retracted when it is not needed, thus no longer presenting an acoustic and/or aerodynamic disturbance.

Furthermore, the development in vehicle manufacturing is increasingly focusing on autonomously and semi-autonomously driving motor vehicles. In order to enable the vehicle controller to control the motor vehicle autonomously or semi-autonomously, a plurality of von environment sensors (e.g., lidar sensors, radar sensors, (multi-)cameras, etc. including other (electrical) components) are employed, which are integrated in the roof module, for example, and which detect the environment surrounding the motor vehicle and determine, for example, a current traffic situation from the detected environment data. Roof modules which are equipped with a plurality of environment sensors are also known as roof sensor modules (RSM). For this purpose, the known environment sensors send and/or receive suitable electromagnetic signals, such as laser beams or radar beams, allowing a data model of the vehicle environment to be generated by suitable signal evaluation and to be used for controlling the vehicle. These environment sensors for monitoring and detecting the vehicle environment are typically mounted on the vehicle roof since the vehicle roof is typically the highest point of a vehicle, from where the vehicle environment is easily visible.

Roof modules of this kind are prefabricated as separate functional modules, which can be delivered to the assembly line when assembling the vehicle. The roof module at least partially forms a roof skin of the vehicle roof at its outer surface, the roof skin preventing moisture and air flows from entering the vehicle interior. The roof skin is composed of one or more panel components, which can be made of a stable material, such as painted metal or painted or died-through plastic. The roof module can be a part of a fixed vehicle roof or a part of an openable roof sub-assembly.

While it is generally known for the environment sensor to be disposed in a panel component of a motor vehicle in a retractable and deployable manner, existing solution approaches present several disadvantages still to be overcome. For one, the environment sensors in the state of the art are often not fully covered when in the retracted state, which means that there is the risk that water enters an opening of the panel component in question and leads to corrosion, for example. Moreover, known adjustment kinematics systems often have a complex technical structure in order to be able to implement an equally complex motion sequence of the environment sensor during retraction and deployment. These adjustment kinematics systems often comprise a plurality of drives in order to execute a complex folding, pivoting and shifting movement of the environment sensor, for example. This makes the production and the structure of existing adjustment kinematics systems technically complex, which is why they often lead to high production costs. Moreover, maintaining adjustment kinematics systems of this kind is complicated and therefore expensive.

### SUMMARY

Hence, the object of the invention is to propose a sensor module which overcomes the disadvantages of the state of the art described above. Furthermore, the object of the invention is to provide a panel component comprising such a sensor module.

This object is attained by a roof module of the teaching of claim 1.

Advantageous embodiments of the invention are the subject matter of the depend-ent claims.

In its intended use, the sensor module according to the invention is configured to be disposed on a panel component (which is part of a vehicle body, for example) of a motor vehicle. The sensor module comprises a sensor housing and at least one environment sensor which is at least partially disposed in the sensor housing and configured to send and/or receive electromagnetic signals to thus detect a vehicle environment. Furthermore, the sensor module according to the invention comprises an adjustment kinematics system having a drive (provided by an electric motor and/or an electric stepper motor, for example) which is configured to move the environment sensor from a retracted position into at least one deployed position. The sensor module according to the invention is characterized in that a cover is disposed on the sensor housing in an adjustable manner and that the drive is configured to move the cover from a covering position into at least one open position. The cover is preferably connected to the sensor housing via at least one guiding bracket. Preferably, the cover forms a kind of visor which can be moved between the covering position and the at least one open position by the drive.

The sensor module according to the invention is advantageous in that an opening in the component is covered by the cover when the environment sensor is in the retracted position, in which the cover is then preferably located in the covering position. This protects the environment sensor from environmental conditions and also prevents water from entering the opening of the panel component. Furthermore, the cover can preferably be configured in the manner and the geometry of a panel component portion in question, which means that the cover preferably appears flush and in one piece with the panel component when in the covering position. The cover can prevent an optically and/or aerodynamically negative effect. The cover can preferably also be flow-optimized so that the cover does not disturb an air flow on the panel component. So the cover is preferably a hatch or a visor which is integrated in the sensor module and which can fully cover an opening in a panel component. Thus, no additional closure of the opening in the retracted position of the environment sensor is needed. This makes the solution according to the invention very compact and optimized for installation space. Moreover, the compact design means that the sensor module according to the invention has a low height and is cost-efficient to produce, all of which is reflected in lower installation and production costs when installed in a motor vehicle.

The expression “at least one” means that, according to the invention, the component mentioned in this context can be comprised once or more than once. For example, the sensor module can comprise one or more than one environment sensor, i.e., at least one environment sensor. The sensor housing can preferably be configured in such a manner that it fully accommodates the environment sensor, preferably fully enclosing it and/or forming a dry area in its interior, in which the environment sensor is protected from moisture. In the “retracted position”, the environment sensor, in its intended use, is preferably disposed in such a manner in an opening of a panel component in question that it does not protrude from the opening. In the “at least one deployed position”, the environment sensor preferably protrudes from a panel component in question so as to thus detect the vehicle environment with as little interference as possible. In the at least one deployed position, the environment sensor preferably protrudes from the panel component at least with a see-through area through which the environment sensor looks during the detection of the vehicle environment. In the “covering position”, the cover preferably closes an opening of a panel component in question in a complete and flush manner. When the cover is in the covering position, the environment sensor is preferably in the retracted position. In the “open position”, the cover preferably uncovers the opening in a panel component in question, meaning it is tilted upward, for example, allowing the environment sensor to move out of the opening unhindered. The cover is preferably first moved from the covering position into the open position before the environment sensor is moved from the retracted position into the at least one deployed position.

In a particularly preferred embodiment, the adjustment kinematics system has a single drive, which is configured to move the environment sensor and the cover through a common motion sequence. So the sensor module according to the invention does not require multiple drives contrary to the state of the art; instead, a single drive suffices to move both the environment sensor and the cover. To this end, the drive causes only one motion sequence to ensure the adjustability. For example, such a motion sequence consists in initially moving the cover from the covering position into the open position. Once the open position has been reached, the environment sensor is moved from the retracted position into the at least one deployed position without interruption in still the same motion sequence. Of course, the drive can also initiate a contrary motion sequence.

In a preferred embodiment, the drive is configured to move the environment sensor from the retracted position into the at least one deployed position in a purely translational manner. So the environment sensor is preferably moved from the retracted position into the deployed position together with the sensor housing by being moved, i.e. displaced, along an axis of movement. So the environment sensor undergoes a purely translational movement and not a rotational movement. This has the advantage that the environment sensor can be guided in a mechanical-ly simple manner. For instance, the environment sensor can preferably be disposed on a guide rail with its sensor housing and be moved back and forth thereon. Additionally, such a motion sequence is not complex because of the purely translational movement.

In a preferred embodiment, the drive is configured to move the cover from the covering position into the at least one open position in a purely rotational manner. So the cover is preferably moved from the covering position into the open position by being moved, i.e., turned, about an axis of rotation. To this end, the cover is particularly preferably mounted on the sensor housing in a rotating manner by means of at least one guiding bracket, for example. The cover is preferably rotated relative to the sensor housing only. The sensor housing, on the other hand, is not turned along with it.

Particularly preferably, the translational axis of movement of the environment sensor is orthogonal to the axis of rotation or the turning axis of the cover. In this manner, a technically very simple design can be selected to combine the two movements in a common motion sequence.

In a preferred embodiment, the adjustment kinematics system comprises a slide. Furthermore, the drive can preferably comprise a drive pinion. The drive is connected to the slide (directly or indirectly (with other components being interposed)) in a force-transmitting manner via a flexible shaft or a spindle nut drive. A flexible shaft or a spindle nut drive or another operative connection (e.g., a lever connection) can be disposed on a preferred drive pinion, for example. The flexible shaft or the spindle nut drive or the operative connection is preferably connected to the drive pinion in a force-transmitting manner on one side. On the other side (with respect to its longitudinal dimension), the flexible shaft or the spindle nut drive or the other operative connection is connected to the slide in a force-transmitting manner. The drive can preferably move the slide along a drive axis.

In the case of the spindle nut drive, the drive moves a spindle nut back and forth relative to a spindle. This relative movement between the spindle nut and the spindle can be translated into a movement of the sliding pin. In the case of the spindle nut drive, the sliding pin is preferably rigidly fixed to the spindle nut, i.e., connected thereto for co-rotation, while its other end engages the slot in a sliding manner.

In a preferred embodiment, the drive is configured to move the slide back and forth (translationally) along the drive axis on an essentially linear track (i.e., considering tolerance- and function-related deviations) by means of the flexible shaft or the spindle nut drive. The drive axis is preferably essentially (±15%) parallel to the axis of movement of the environment sensor.

In a preferred embodiment, a slot in which a sliding pin is supported in a translationally mobile manner is provided in the slide. The sliding pin is preferably disposed on the sensor housing and/or a spindle nut of a spindle nut drive in a translationally immobile manner. The sliding pin or the guiding pin can preferably slide in the slot. The movement of the sliding pin along or in the slot can induce both the rotational movement of the cover relative to the sensor housing and the translational movement of the environment sensor, which moves the environment sensor from the retracted position into the deployed position. The slide is preferably guided on a linear track (e.g., similar to a rail). The slot is preferably a prede-fined slot in the slide, whose shape and length allow an intended motion sequence to be executed. It is particularly preferable for the slot to comprise a first slot end section and a second slot section (i.e. an S-shape). Other shapes of the slots are also possible in principle. An advantage of a slot control is that this makes it possible for the environment sensor to be moved in a speed-optimized manner while less installation space is required for the adjustment mechanics. The sliding pin is preferably secured against dropping out of the slot (e.g., by means of a protruding bulge (similar to a rivet) or by means of a split pin).

The drive is preferably an electric motor. A high degree of freedom of design can be ensured by providing the flexible shaft, which translates a (rotational) movement of the motor into a linear movement of the slide via the drive pinion, since the drive can almost entirely freely be placed laterally next to the environment sensor in an extending installation space. Particularly preferably, the drive is configured to move the slide back and forth along an essentially linear track by means of the flexible shaft. The expression “an essentially linear track” means that the slide can preferably be moved along one axis of movement only (e.g., parallel to the vehicle width direction), whereas it is limited in its movement (except for the provision of a constructively required backlash) regarding the other two axes of movement (i.e., it has only one degree of freedom of movement).

In a preferred embodiment, the slot comprises at least one first slot section and a second slot section. The second slot section is preferably inclined or angled relative to the first slot section. The slot is preferably essentially S-shaped. The drive is configured to move the slide in such a manner that the sliding pin moves the cover from the covering position into the at least one open position when the sliding pin slides in the second slot section and to move the slide in such a manner that the sliding pin moves the environment sensor from the retracted position into the at least one deployed position when the sliding pin slides in the first slot section. The movement of the sliding pin along the second slot section induces the rotational movement of the cover relative to the sensor housing about the axis of rotation. The movement of the sliding pin along the first slot induces the translational movement of the environment sensor or the sensor housing along its axis of movement. Since the slot control or the slide comprises a single slot, which is divided into the first and the second slot section, a combined motion sequence can be executed.

In one embodiment, it can be preferred for the sensor module to comprise at least one cleaning nozzle which is disposed in an area laterally next to the see-through area of the environment sensor so as to clean the latter with a cleaning fluid (e.g., a gas or a liquid (e.g., soapy water)) as needed. For example, the at least one cleaning nozzle can be provided in the housing portion in which the see-through area is also disposed. The cleaning nozzle can be retractable and deployable or be fixed. If the cleaning nozzle is retractable and deployable, it can be advantageous for the cleaning nozzle to be retracted and deployed by water pressure or a mechanical drive. It is basically also conceivable for the slot to comprise another slot section, such as a ramp-shaped slot section, and for the at least one cleaning nozzle to be retractable and deployable by the sliding pin when the latter moves in this ramp-shaped third slot section. Thus, it can be possible for the movement of the cover, the environment sensor, and the cleaning nozzle to be provided via a single motion sequence (by the movement of the sliding pin in the slot), the individual movements of the cover, the environment sensor, and the cleaning nozzle also being possible independently of each other (i.e., by partial execution of the motion sequence).

Basically any type of environment sensor can be comprised in the sensor module. It is particularly advantageous for the sensor module according to the invention to comprise a lidar sensor and/or a radar sensor and/or a camera sensor and/or an ultrasound sensor and/or a multi-camera sensor as an environment sensor. Lidar sensors operate in a wavelength range of 905 nm or approx. 1550 nm, for example. The sensor module preferably comprises a see-through area through which the environment sensor looks in order to detect a vehicle environment. The material of the see-through area is preferably transparent to the wavelength range used by the environment sensor and is selected as a function of the wavelength(s) used by the environment sensor. Other environment sensors, which are not mentioned here, can also be employed in principle.

Particularly preferably, the invention also relates to a panel component of a motor vehicle, the panel component having at least one opening in which the at least one sensor module according to the invention is disposed in an adjustable manner. The cover is preferably configured in such a manner that it closes the at least one opening in a flush and preferably moisture-proof manner when the environment sensor is in the retracted position and the cover is in the covering position. The shape of the cover preferably matches the shape of the opening, with production- and function-related tolerances being observed, so that it can close the opening.

The cover can preferably have a shape which is adapted to the geometry of the panel component in terms of its area, resulting in an optically balanced appearance. The cover can preferably comprise a seal which is disposed circumferentially at an outer edge area of the cover and ensures sealing relative to the panel component. Alternatively or additionally, a seal can also be disposed on the panel component in an edge area of the opening, for example. The cover preferably comes into flush contact with the seal when in the covering position so that a liquid-tight sealing relative to the opening is possible.

The sensor housing preferably comprises a housing portion having a see-through area through which the environment sensor looks in order to detect the vehicle environment. The housing portion is preferably configured in such a manner that it closes the at least one opening in a flush and preferably moisture-proof manner when the environment sensor is in the at least one deployed position and the cover is in the open position. The shape of the housing portion preferably matches the shape of the opening, with production- and function-related tolerances being observed, so that it can close the opening. The housing portion can preferably have a shape which is adapted to the geometry of the panel component in terms of its area, resulting in an optically balanced appearance. The housing portion can preferably comprise a seal which is disposed circumferentially at an outer edge area of the housing portion and ensures sealing relative to the panel component. Alternatively or additionally, a seal can also be disposed on the panel component in an edge area of the opening, for example. The housing portion preferably comes into flush contact with the seal when in the open position so that a liquid-tight sealing relative to the opening is possible.

In another preferred embodiment, the panel component is a fender, a bumper, or an exterior paneling component of a sunroof, a window, a door, a sliding roof, a top, a folding top, a hood, a front hood or a trunk lid. Other panel components of a motor vehicle, which are not mentioned here, are also comprised by the invention in principle. Of course, a motor vehicle can also comprise several of the panel components mentioned above, which can preferably each comprise at least one sensor module according to the invention.

Particularly preferably, the present invention also relates to a roof module for forming a vehicle roof on a motor vehicle, the roof module comprising a panel component which at least partially forms a roof skin of the vehicle roof. The roof skin serves as an exterior sealing surface of the roof module. The panel component, which forms the roof skin, comprises at least one sensor module according to the invention according to one of the embodiments of the present invention.

The invention also relates to a motor vehicle comprising at least one panel component according to the invention. Particularly preferably, the invention relates to a motor vehicle comprising a roof frame structure and a roof module of the kind mentioned above, which can be installed on top of the roof frame structure as a structural unit.

The roof module according to the invention can form a structural unit in which features for autonomous or semi-autonomous driving assisted by driver assistance systems are integrated and which can be placed on top of a vehicle body shell as a structural unit by a vehicle manufacturer. Furthermore, the roof module according to the invention can be a purely fixed roof or a roof including a roof opening system. Moreover, the roof module can be configured for use in a passenger car or in a utility vehicle. The roof module can preferably be provided as a structural unit in the form of a roof sensor module (RSM), in which the environment sensors are provided, so as to be used in a roof frame of a vehicle body as a suppliable structural unit.

Of course, the embodiments and illustrative examples mentioned above and yet to be explained can be realized not only individually but also in any combination with each other without departing from the scope of the present invention. Moreover, any and all embodiments and illustrative examples of the sensor module also relate to a panel component, in particular also a roof module, which comprises such a sensor module and to a motor vehicle which comprises such a panel component, in particular such a roof module.

An embodiment of the invention is schematically illustrated in the drawing and will be discussed as an example below.

### BRIEF DESCRIPTIONS OF THE DRAWINGS

FIG. 1 is a perspective view of a motor vehicle having multiple panel components and at least one sensor module according to the invention;

FIG. 2 is a detail view of a panel component with an illustrative example of a sensor module according to the invention in a first position;

FIG. 3 is a detail view of a panel component with an illustrative example of a sensor module according to the invention in a second position;

FIG. 4 is a detail view of a panel component with an illustrative example of a sensor module according to the invention in a plan view;

FIG. 5 is a detail view of a panel component with an illustrative example of a sensor module according to the invention in a plan view;

FIG. 6 is a detail view of a panel component with an illustrative example of a sensor module according to the invention in a side view;

FIG. 7 is a detail view of a panel component with an illustrative example of a sensor module according to the invention in a side view;

FIG. 8 is a detail view of a panel component with an illustrative example of a sensor module according to the invention in a first position;

FIG. 9 is a detail view of a panel component with an illustrative example of a sensor module according to the invention in a second position;

FIG. 10 is a detail view of an illustrative example of a sensor module according to the invention in a first perspective view;

FIG. 11 is a detail view of an illustrative example of a sensor module according to the invention in a second perspective view;

FIG. 12 is a detail view of an illustrative example of a sensor module according to the invention in a third perspective view;

FIG. 13 are multiple views (a) to (d) for tracking a motion sequence executed by the sensor module when moved by means of a flexible shaft drive; and

FIG. 14 are multiple views (a) to (c) for tracking a motion sequence executed by the sensor module when moved by means of a spindle nut drive.

### DETAILED DESCRIPTION

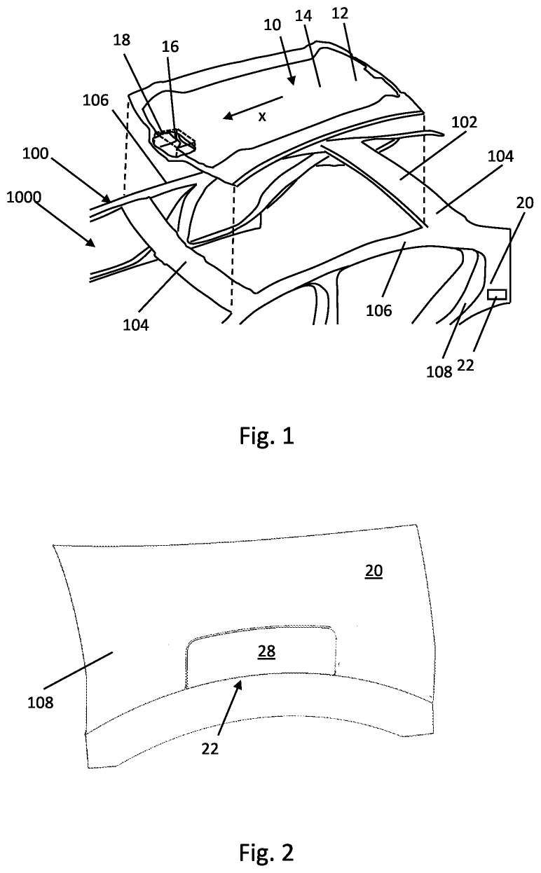

FIG. 1 shows a motor vehicle 1000 having a vehicle roof 100. Vehicle roof 100 is formed by a roof module 10 in the case at hand. Roof module 10 can be placed on a roof frame structure 102 of the motor vehicle body as a structural unit, which is indicated by dashed lines. Roof module 10 comprises a first panel component 12 for forming a roof skin 14 of vehicle roof 100. A first sensor module 16 is disposed in a retractable and deployable manner in an opening of first panel component 12 in a front center roof area of roof module 10 with respect to a longitudinal vehicle direction x. First sensor module 16 is disposed directly behind a front transverse rail 104, which defines a header of the roof of the vehicle. The front transverse rail forms roof frame structure 102 together with rear transverse rail 104 and two side rails 106.

First sensor module 16 comprises an environment sensor 18, which can be a lidar sensor, for example. Other sensor types, such as (multi-directional) cameras and/or ultrasound sensors can be employed, as well. Furthermore, sensor module 16 comprises a sensor housing 19, in which environment sensor 18 is at least partially disposed. Sensor housing 19 can be a partial housing or a housing portion. Environment sensor 18 is configured to send and/or receive electromagnetic signals to thus detect a vehicle environment of motor vehicle 1000 (e.g., for autonomous driving or for parking).

In addition to roof frame structure 102, the motor vehicle body comprises other components which are each covered by panel components, which form a respective roof skin of the motor vehicle. For example, the motor vehicle body comprises a fender 108, a fender of a rear wheel (not shown) being illustrated in the case at hand. Fender 108 is covered by an appropriately shaped second panel component 20, which defines an outer skin of fender 108. A second sensor module 22 is disposed in a retractable and deployable manner in an opening of second panel component 20. First sensor module 16 and second sensor module 22 can be equivalent or technically different sensor modules (e.g., with different environment sensors 18). Explanations relating to first sensor module 16 equivalently relate to second sensor module 22. Explanations relating to second sensor module 22 equivalently also relate to first sensor module 16. Hence, second sensor module 22 will also simply be referred to as sensor module 16, 22 below.

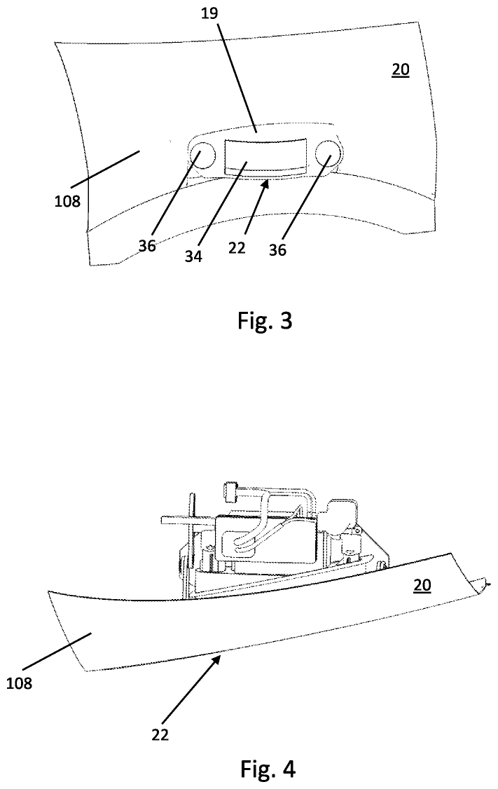

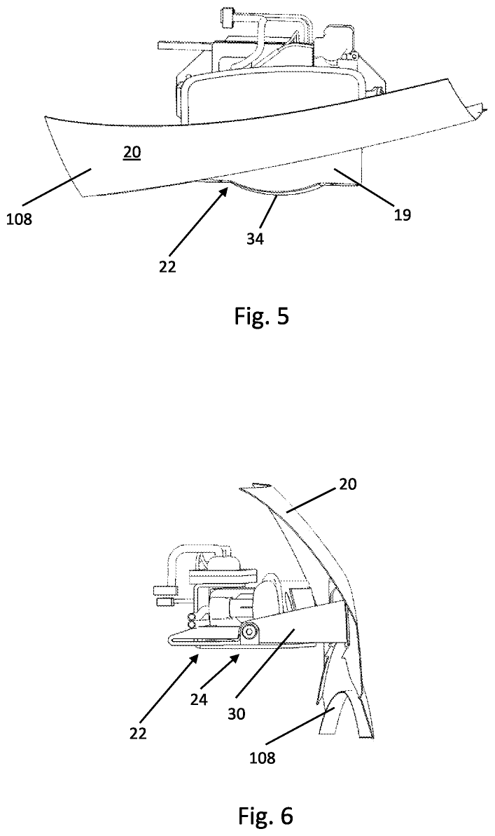

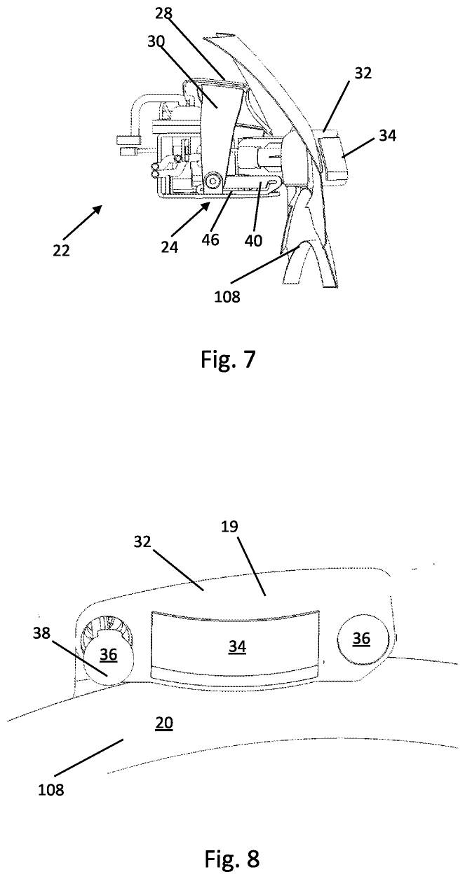

FIG. 2 shows a detail view of a section of a fender 108, which comprises an opening in which sensor module 16, 22 is disposed in a retractable and deployable manner. Sensor module 16, 22 further comprises an adjustment kinematics system 24 (see FIGS. 6 and 7 and 13 and 14), which has a drive 26, which is configured to move environment sensor 18 from a retracted position (see FIGS. 2, 4, 6, 13(a) and 14(a)) into at least one deployed position (see FIGS. 3, 5, 7 to 9 and 13(c)-(d) and 14(b) and (c)). Drive 26 is schematically indicated in FIG. 10 and can be provided by an electric motor or an electric stepper motor. Other drives or types of drives (mechanical and/or pneumatic drives) are conceivable, as well.

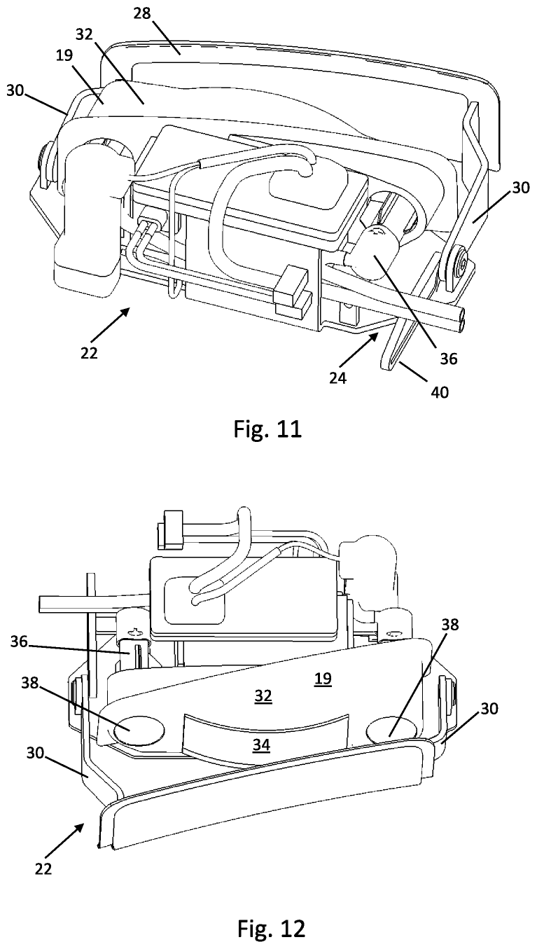

Furthermore, sensor module 16, 22 according to the invention comprises a cover 28, which is supported on sensor housing 19 in a rotating manner by two guiding brackets 30. Guiding brackets 30 can differ from each other in length if cover 28 is oriented at an angle to a transverse direction of sensor module 16, 22, for example. According to the invention, drive 26 is configured to move cover 28 from a covering position (see FIGS. 2, 4, 6, 10 to 12, 13(a) and 14(a)) into at least one open position (see FIGS. 3, 5, 7, 13(c)-(d) and 14 (b)-(c)).

Sensor housing 19 comprises a housing portion 32, which has a see-through area 34, through which environment sensor 18 looks in order to detect the vehicle environment. Housing portion 32 is configured in such a manner that it closes the at least one opening in a flush and preferably moisture-proof manner when environment sensor 18 is in the at least one deployed position and cover 28 is in the open position, as can be seen in FIGS. 3, 5, 8 and 9. A cross section of housing portion 32 preferably corresponds to a cross section of the opening, tolerances considered.

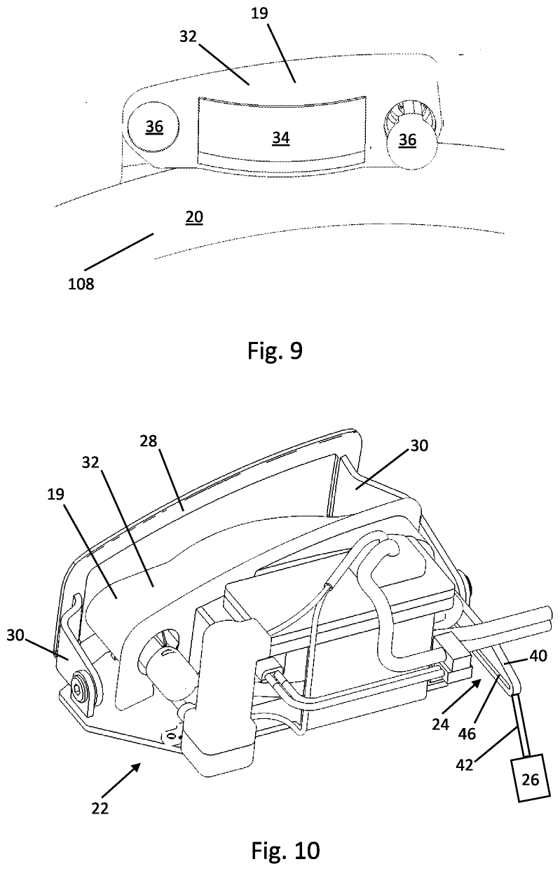

Sensor module 16, 22 can further comprise at least one cleaning nozzle 36. In the examples shown, sensor module 16, 22 comprises two cleaning nozzles, which are disposed in a retractable and deployable manner in openings in sensor housing 19 or housing portion 32. Cleaning nozzles 36 are disposed laterally next to see-through area 34 (with respect to a line of sight of environment sensor 18). When cleaning nozzles 36 are in the retracted position, the respective openings are closed in a flush manner by lid parts 38. In the case at hand, cleaning nozzles 36 can be deployed by water pressure. The retracting function of cleaning nozzles 36 can be provided by a return spring (not shown), for example. Cleaning nozzles 36 are configured to clean see-through area 34. To this end, cleaning nozzles 36 spray a cleaning fluid onto see-through area 34 in the form of a fluid cone. The fluid cone strikes see-through area 34 at an angle when cleaning nozzles 36 are disposed in such a lateral manner. The disposition of cleaning nozzles 36 is advantageous since they are disposed outside of the field of view of environment sensor 18. In FIG. 8, left cleaning nozzle 36 is deployed as an example. In FIG. 9, right cleaning nozzle 36 is deployed as an example.

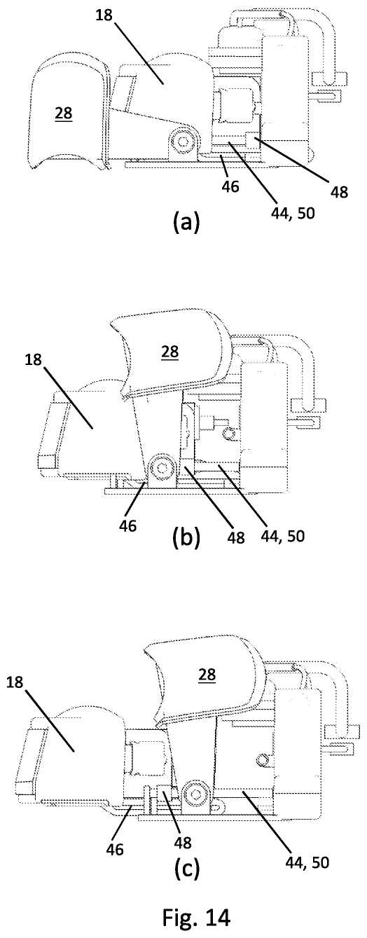

According to the invention, adjustment kinematics system 24 comprises a slide 40. Drive 26 can preferably comprise a drive pinion (not shown). A flexible shaft 42 (see schematically indicated in FIG. 10) can be disposed on such a drive pinion, for example. Alternatively, drive 26 can also be connected to slide 40 in a force-transmitting manner via a spindle nut drive 44 (see FIGS. 14(a) to 14(c)). Drive 26 is configured to move slide 40 back and forth along an essentially linear track by means of flexible shaft 42 or spindle nut drive 44.

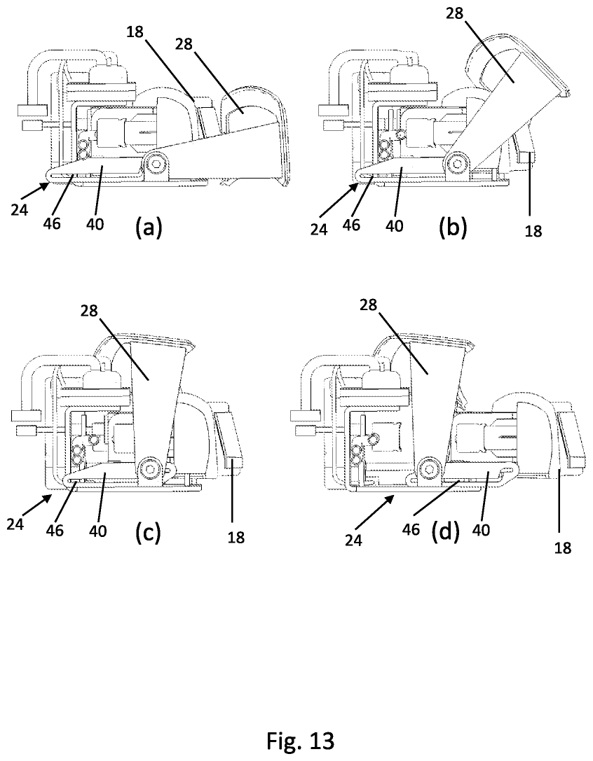

A slot 46, in which a sliding pin (not shown since it is covered by guide levers 30) is supported in a translationally mobile manner, is provided in slide 40. The sliding pin can be fixed (in a translationally immobile manner) to sensor housing 19 in the case of flexible shaft 42. In the case of spindle nut drive 44, the sliding pin can be fixed (in a translationally immobile manner) to a spindle nut 48 of spindle nut drive 44. Spindle nut drive 44 further comprises a spindle 50, which can rotate relative to spindle nut 48 so that spindle nut 48 can be moved back and forth on spindle 50 by the action of drive 26 (see FIG. 13).

Slot 46 comprises at least one first slot section (see in particular FIGS. 13 and 14) and a second slot section, which is angled relative to the first slot section (see FIG. 13(d)), drive 26 being configured to move slide 40 in such a manner that the sliding pin slides in the second slot section, whereby cover 28 can be moved from the covering position into the at least one open position, and to move slide 40 in such a manner that the sliding pin slides in the straight slot section, whereby environment sensor 18 can be moved from the retracted position into the at least one deployed position.

FIGS. 13 and 14 each depict a motion sequence of sensor module 16, 22 in respective snapshots. In particular, they depict the respective positions of adjustment kinematics system 24. Adjustment kinematics system 24 differs in the illustrative examples shown in FIGS. 13 and 14.

FIG. 13(a) shows sensor module 16, 22 in a position in which environment sensor 18 is fully located in the retracted position, i.e., the inactive position. Cover 28 is located in the covering position, i.e., the closed position, in which it closes the opening in panel component 12, 20 in a preferably flush manner. In FIG. 13(b), cover 28 is in the opening process between the covering position and the open position. Environment sensor 18 is still fully retracted. In FIG. 13(c), cover 28 is in the open position, i.e., it is not opened further. Environment sensor 18 is in the deploying movement between the retracted position and the fully deployed position. In this intermediate position, environment sensor 18 can basically detect the vehicle environment already. In FIG. 13(d), cover 28 is in the open position, i.e., it is not opened further. Environment sensor 18 is in the fully deployed position.

In FIG. 14(a), sensor module 16, 22 is shown in a position in which environment sensor 18 is in the fully retracted position, i.e., the inactive position. Cover 28 is in the covering position, i.e., the closed position, in which it closes the opening in panel component 12, 20 in a preferably flush manner. In FIG. 14(b), cover 28 is in the open position. Environment sensor 18 is in the process of being moved from the retracted position into the deployed position and is located in an intermediate position between these two positions. In FIG. 14(c), environment sensor 18 is in the fully deployed position. Cover 28 is in the open position.

1. A sensor module for attachment to a panel component of a motor vehicle, the sensor module comprising:
a sensor housing,
at least one environment sensor disposed at least partially in the sensor housing and configured to send and/or receive electromagnetic signals to thus detect a vehicle environment, and
an adjustment kinematics system having a drive configured to move the environment sensor from a retracted position into at least one deployed position,
wherein a cover is disposed on the sensor housing in an adjustable manner and that the drive is configured to move the cover from a covering position into at least one open position.

2. The sensor module according to claim 1, wherein the adjustment kinematics system has a single drive, which is configured to move the at least one environment sensor and the cover through a common motion sequence.

3. The sensor module according to claim 1, wherein the drive is configured to translationally move the environment sensor from the retracted position into the at least one deployed position.

4. The sensor module according to claim 1, wherein the drive is configured to rotationally move the cover from the covering position into the at least one open position.

5. The sensor module according to claim 1, wherein the adjustment kinematics system comprises a slide, and the drive is connected to the slide in a force-transmitting manner via a flexible shaft or a spindle nut drive.

6. The sensor module according to claim 5, wherein the drive is configured to move the slide back and forth along an essentially linear track by the flexible shaft or the spindle nut drive.

7. The sensor module according to claim 5, wherein a slot is provided in the slide, a sliding pin rigidly connected to the sensor housing and/or a spindle nut of the spindle nut drive being supported in the slot in a translationally mobile manner.

8. The sensor module according to claim 5, wherein the slot comprises at least one first slot section and a second slot section, which is inclined relative to the first slot section, the drive being configured to move the slide in such a manner that the sliding pin slides in the second slot section, which allows the cover to be moved from the covering position into the at least one open position, and to move the slide in such a manner that the sliding pin slides in the first slot section, which allows the environment sensor to be moved from the retracted position into the at least one deployed position.

9. The sensor module according to claim 1, wherein the at least one environment sensor comprises a lidar sensor and/or a radar sensor and/or a camera sensor and/or a multi-camera sensor and/or an ultrasound sensor.

10. A panel component of a motor vehicle, the panel component having at least one opening in which at least one sensor module according to claim 1 is disposed in an adjustable manner, the cover being configured in such a manner that it covers the at least one opening in a flush and preferably moisture-proof manner when the environment sensor is in the retracted position and the cover is in the covering position.

11. The panel component according to claim 10, wherein the sensor housing comprises a housing portion having a see-through area through which the environment sensor looks in order to detect the vehicle environment and that the housing portion is configured in such a manner that it covers the at least one opening in a flush and preferably moisture-proof manner when the environment sensor is in the deployed position and the cover is in the open position.

12. The panel component according to claim 10, wherein the panel component is a fender, a bumper, or an exterior paneling component of a sunroof, a window, a door, a sliding roof, a top, a folding top, a hood, a front hood or a trunk lid.

13. A roof module for forming a vehicle roof on a motor vehicle, the roof module comprising a panel component according to claim 10, which at least partially forms a roof skin of the vehicle roof and serves as an exterior sealing surface of the roof module.

14. A motor vehicle comprising at least one panel component according to claim 10.

15. A motor vehicle comprising a roof frame structure and a roof module according to claim 13, which is configured to be mounted on the roof frame structure as a structural unit.
